(19) United States
(12) Patent Application Publication
(10) Pub. No.: US 2012/0058216 A1
(43) Pub. Date: Mar. 8, 2012

(54) Method For Forming An Anodized Layer, Method For Manufacturing A Mold, and Mold

(75) Inventor: Ichiroh Ihara, Osaka (JP)

(73) Assignee: SHARP KABUSHIKI KAISHA, Osaka-shi, Osaka (JP)

(21) Appl. No.: 13/319,014

(22) PCT Filed: May 6, 2010
(86) PCT No.: PCT/JP2010/057762

§ 371 Date: Nov. 4, 2011

(30) Foreign Application Priority Data
May 8, 2009 (JP) 2009-113887

(51) Int. Cl. B29C 59/02; C25D 11/16; C25D 7/00; B29C 33/56

(52) U.S. Cl. 425/385; 249/114.1; 205/112

(57) ABSTRACT

An anodized layer formation method of at least one example embodiment of the present invention includes the steps of: (a) providing an aluminum base which has a machined surface; (b) forming, in the surface of the aluminum base, a minute uneven structure which has a smaller average neighboring distance than an average neighboring distance of a plurality of minute recessed portions that an intended porous alumina layer has; and (c) after step (b), anodizing the surface of the aluminum base, thereby forming a porous alumina layer which has the plurality of minute recessed portions. According to at least one embodiment the present invention, a porous alumina layer which has uniformly-distributed minute recessed portions can be formed over a machined surface of an aluminum base.

### TECHNICAL FIELD

The present invention relates to a method for forming an anodized layer, a method for manufacturing a mold, and a mold. In this specification, the “mold” includes molds that are for use in various processing methods (stamping and casting), and is sometimes referred to as a stamper. The mold can also be used for printing (including nanoprinting).

### BACKGROUND ART

Display devices for use in TVs, cell phones, etc., and optical elements, such as camera lenses, etc., usually adopt an antireflection technique in order to reduce the surface reflection and increase the amount of light transmitted therethrough. This is because, when light is transmitted through the interface between media of different refractive indices, e.g., when light is incident on the interface between air and glass, the amount of transmitted light decreases due to, for example, Fresnel reflection, thus deteriorating the visibility.

An antireflection technique which has been receiving attention in recent years is forming over a substrate surface a very small uneven pattern in which the interval of recessed portions or raised portions is not more than the wavelength of visible light (λ=380 nm to 780 nm). See Patent Documents 1 to 4. The two-dimensional size of a raised portion of an uneven pattern which performs an antireflection function is not less than 10 nm and less than 500 nm.

This method utilizes the principles of a so-called motheye structure. The refractive index for light that is incident on the substrate is continuously changed along the depth direction of the recessed portions or raised portions, from the refractive index of a medium on which the light is incident to the refractive index of the substrate, whereby reflection of a wavelength band that is subject to antireflection is prevented.

The motheye structure is advantageous in that it is capable of performing an antireflection function with small incident angle dependence over a wide wavelength band, as well as that it is applicable to a number of materials, and that an uneven pattern can be directly formed in a substrate. As such, a high-performance antireflection film (or antireflection surface) can be provided at a low cost.

As the method for forming a motheye structure, using an anodized porous alumina layer which is obtained by means of anodization (or “anodic oxidation”) of aluminum has been receiving attention (Patent Documents 2 to 4).

Now, the anodized porous alumina layer which is obtained by means of anodization of aluminum is briefly described. Conventionally, a method for forming a porous structure by means of anodization has been receiving attention as a simple method for making nanometer-scale micropores (very small recessed portions) in the shape of a circular column in a regular arrangement. An aluminum base is immersed in an acidic electrolytic solution of sulfuric acid, oxalic acid, phosphoric acid, or the like, or an alkaline electrolytic solution, and this is used as an anode in application of a voltage, which causes oxidation and dissolution. The oxidation and the dissolution concurrently advance over a surface of the aluminum base to form an oxide film which has micropores over its surface. The micropores, which are in the shape of a circular column, are oriented vertical to the oxide film and exhibit a self-organized regularity under certain conditions (voltage, electrolyte type, temperature, etc.). Thus, this anodized porous alumina layer is expected to be applied to a wide variety of functional materials.

A porous alumina layer manufactured under specific conditions includes cells in the shape of a generally regular hexagon which are in a closest packed two-dimensional arrangement when seen in a direction perpendicular to the film surface. Each of the cells has a micropore at its center. The arrangement of the micropores is periodic. The cells are formed as a result of local dissolution and growth of a coating. The dissolution and growth of the coating concurrently advance at the bottom of the micropores which is referred to as a barrier layer. As known, the size of the cells, i.e., the interval between adjacent micropores (the distance between the centers), is approximately twice the thickness of the barrier layer, and is approximately proportional to the voltage that is applied during the anodization. It is also known that the diameter of the micropores depends on the type, concentration, temperature, etc., of the electrolytic solution but is, usually, about ⅓ of the size of the cells (the length of the longest diagonal of the cell when seen in a direction vertical to the film surface). Such micropores of the porous alumina may constitute an arrangement which has a high regularity (periodicity) under specific conditions, an arrangement with a regularity degraded to some extent depending on the conditions, or an irregular (non-periodic) arrangement.

Patent Document 2 discloses a method for producing an antireflection film (antireflection surface) with the use of a stamper which has an anodized porous alumina film over its surface.

Patent Document 3 discloses the technique of forming tapered recesses with continuously changing pore diameters by repeating anodization of aluminum and a pore diameter increasing process.

The present applicant discloses in Patent Document 4 the technique of forming an antireflection film with the use of an alumina layer in which very small recessed portions have stepped side surfaces.

As described in Patent Documents 1, 2, and 4, by providing an uneven structure (macro structure) which is greater than a motheye structure (micro structure) in addition to the motheye structure, the antireflection film (antireflection surface) can be provided with an antiglare function. The two-dimensional size of a raised portion of the uneven structure which is capable of performing the antiglare function is not less than 1 μm and less than 100 μm. The entire disclosures of Patent Documents 1, 2, and 4 are herein incorporated by reference.

Utilizing such an anodized porous aluminum film can facilitate the manufacturing of a mold which is used for formation of a motheye structure over a surface (hereinafter, “motheye mold”). In particular, as described in Patent Documents 2 and 4, when the surface of the anodized aluminum film as formed is used as a mold without any modification, a large effect of reducing the manufacturing cost is achieved. The structure of the surface of a motheye mold which is capable of forming a motheye structure is herein referred to as “inverted motheye structure”.

Patent Document 5 describes forming a plurality of recesses in a smooth surface of a aluminum plate before anodization of the aluminum plate such that the arrangement and interval of the recesses are identical with those of micropores of an alumina film formed by anodization. In this way, a porous alumina layer is formed which has regularly-arranged micropores (minute recessed portions) of a predetermined shape such that the interval and arrangement of the micropores are identical with those of the plurality of recesses formed before the anodization. Patent Document 5 also discloses that, to obtain micropores of higher straightness, verticality, and independency, it is desired that the surface of the aluminum plate has improved smoothness.

### CITATION LIST

### Patent Literature

Patent Document 1: Japanese PCT National Phase Laid-Open Publication No. 2001-517319

Patent Document 2: Japanese PCT National Phase Laid-Open Publication No. 2003-531962 Patent Document 3: Japanese Laid-Open Patent Publication No. 2005-156695

Patent Document 4: WO 2006/059686

Patent Document 5: Japanese Laid-Open Patent Publication No. 10-121292

### SUMMARY OF INVENTION

### Technical Problem

The present inventor attempted to manufacture a motheye mold using an aluminum base which has a mirror-finished surface produced by cutting (hereinafter, simply referred to as “mirror-cut surface”) but obtained only a porous alumina layer which has minute recessed portions in a nonuniform distribution. An example of the experimental result is described below.

As shown in FIG. 8(a), an aluminum base which had a mirror-cut surface (curved surface) was provided. This resultant aluminum base was anodized, and a striped pattern such as shown in FIG. 8(b) was observed by a human eye. Observing this surface by SEM, it was found that the formation density of the minute recessed portions was low and that the distribution of the minute recessed portions was nonuniform as shown in FIG. 8(c). The minute recessed portions were present in higher densities in regions which appear as white stripes in FIG. 8(b). The white stripes formed were parallel to the directions of a bit which traveled across the aluminum base surface in a cutting process for mirror finishing.

Thus, anodizing a surface of the aluminum base in which a mechanically damaged layer (hereinafter, simply referred to as “damaged layer”) has been formed by machining disadvantageously leads to nonuniform formation of minute recessed portions.

Forming a porous alumina layer in a machined surface is important for, for example, manufacturing of a mold in the form of a roll which is capable of uninterrupted performance of the transfer step.

The present invention was conceived for the purpose of solving the above problems. One of the major objects of the present invention is to provide an anodized layer formation method that enables formation of a porous alumina layer which has minute recessed portions uniformly distributed in a machined surface of an aluminum base. Another object of the present invention is to provide a method that enables formation of a porous alumina layer which has recessed portions uniformly distributed across the perimeter surface of a mold that is in the form of a roll.

### Solution to Problem

An anodized layer formation method of the present invention includes the steps of: (a) providing an aluminum base which has a machined surface; (b) allowing passage of an electric current between the surface of the aluminum base and a counter electrode, with the surface of the aluminum base being a cathode, in water or an aqueous solution whose specific resistance value is not more than 1 MΩ·cm; and (c) after step (b), anodizing the surface of the aluminum base, thereby forming a porous alumina layer. The passage of an electric current in step (b) is sometimes referred to as “cathode electrolysis”.

Another anodized layer formation method of the present invention includes the steps of: (a) providing an aluminum base which has a machined surface; (b) forming, in the surface of the aluminum base, a minute uneven structure which has a smaller average neighboring distance than an average neighboring distance of a plurality of minute recessed portions that an intended porous alumina layer has; and (c) after step (b), anodizing the surface of the aluminum base, thereby forming a porous alumina layer which has the plurality of minute recessed portions.

In one embodiment, step (b) includes performing electrolytic polishing on the surface of the aluminum base.

In one embodiment, step (b) includes bringing the surface of the aluminum base into contact with an etchant.

In one embodiment, the machined surface is a mirror-finished surface.

In one embodiment, the aluminum base is in the form of a roll.

Still another anodized layer formation method of the present invention includes the steps of: (a) providing a base in the form of a roll; (b) depositing an aluminum layer on a perimeter surface of the base that is in the form of a roll; and (c) anodizing the surface of the aluminum layer, thereby forming a porous alumina layer which has a plurality of minute recessed portions.

An inventive method for manufacturing a mold which has an inverted motheye structure in its surface includes the step of forming a porous alumina layer according to any of the above anodized layer formation methods, the porous alumina layer having a plurality of minute recessed portions whose two-dimensional size viewed in a direction normal to the surface is not less than 10 nm and less than 500 nm.

A mold of the present invention includes: an aluminum base which has a mechanically damaged layer; and a porous alumina layer formed on the mechanically damaged layer. Particularly, the porous alumina layer has an inverted motheye structure which is preferably used in formation of an antireflection structure.

### Advantageous Effects of Invention

According to the present invention, a porous alumina layer which has uniformly-distributed minute recessed portions can be formed over a machined surface of an aluminum base. Also, according to the present invention, a porous alumina layer which has uniformly-distributed minute recessed portions can be formed over a perimeter surface of a base that is in the form of a roll. It is possible to manufacture a mold which has an inverted motheye structure in its surface using an anodized layer formation method of the present invention. A motheye mold of the present invention is suitably used in formation of an antireflection structure.

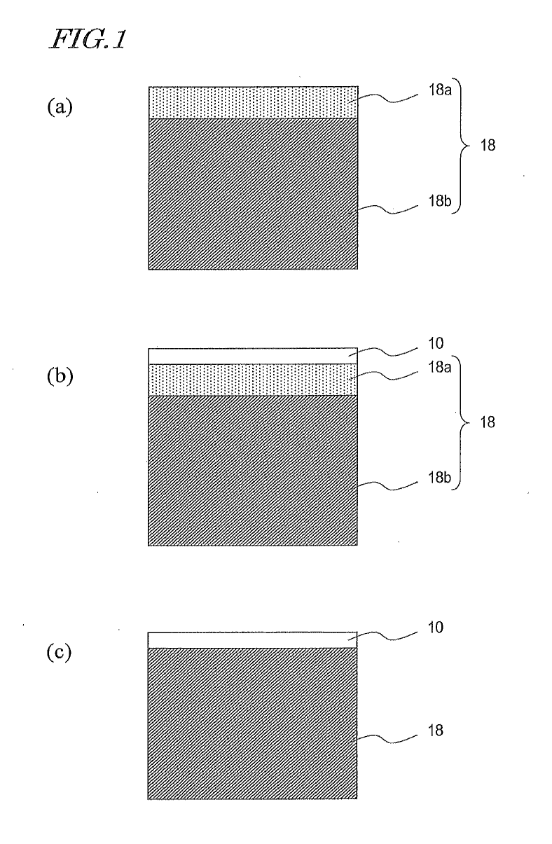

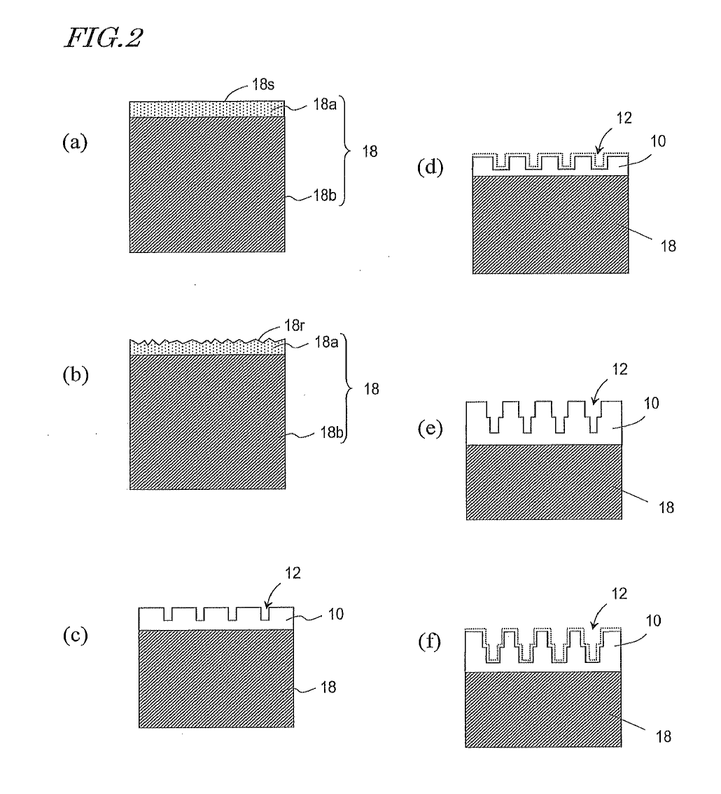

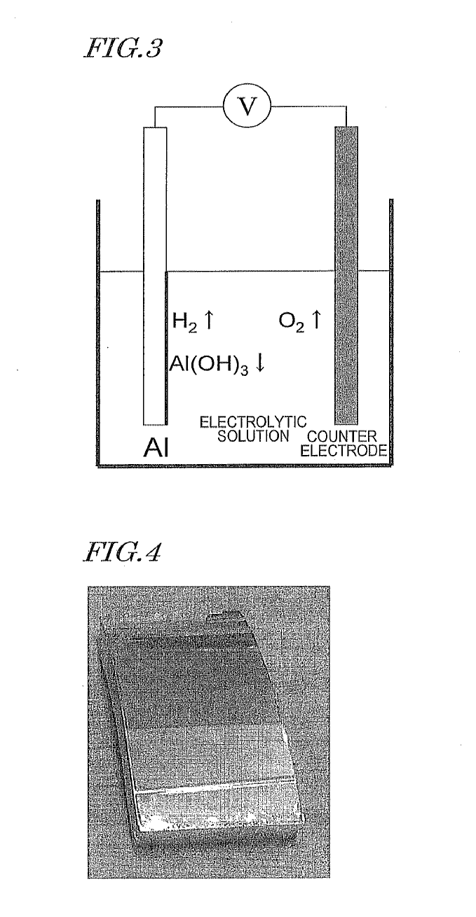

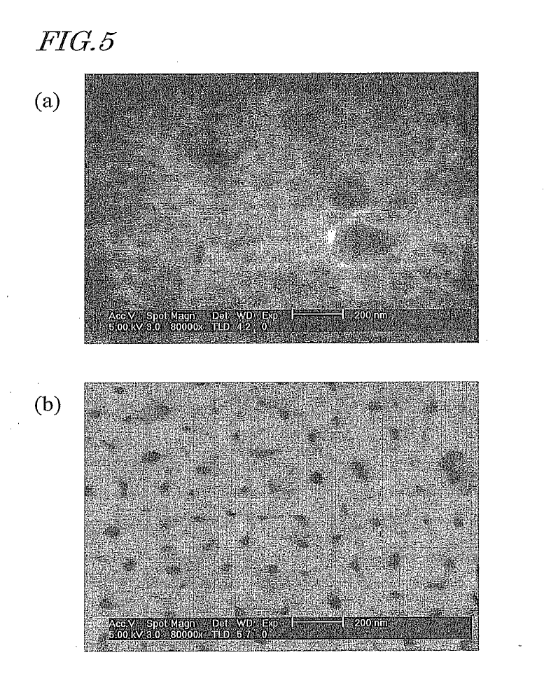

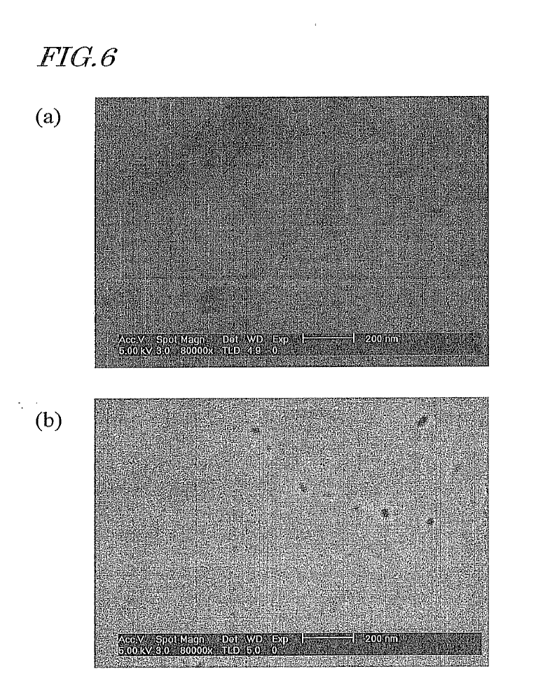

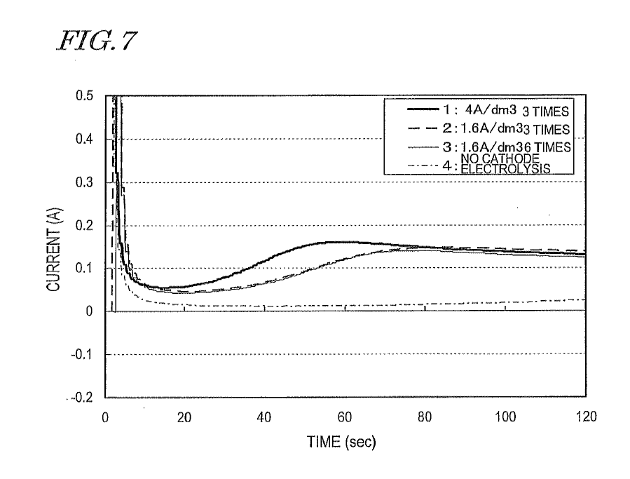

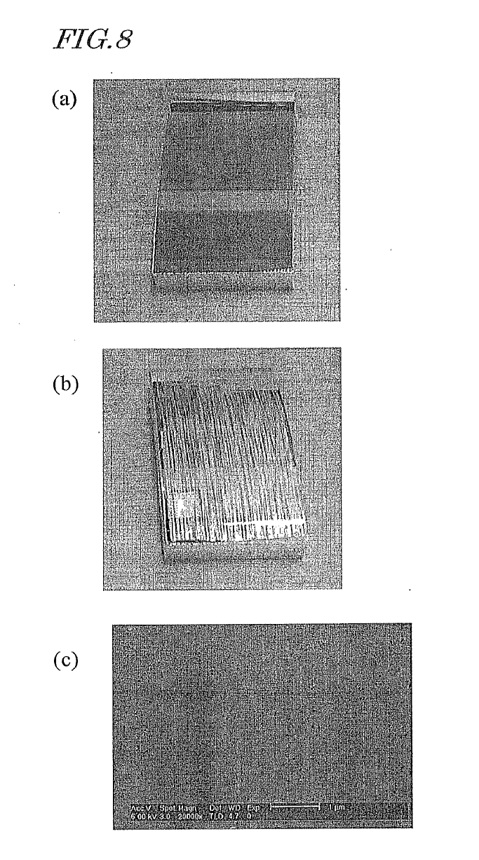

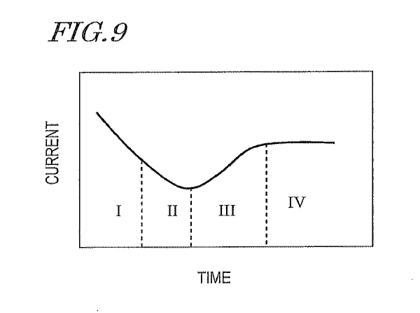

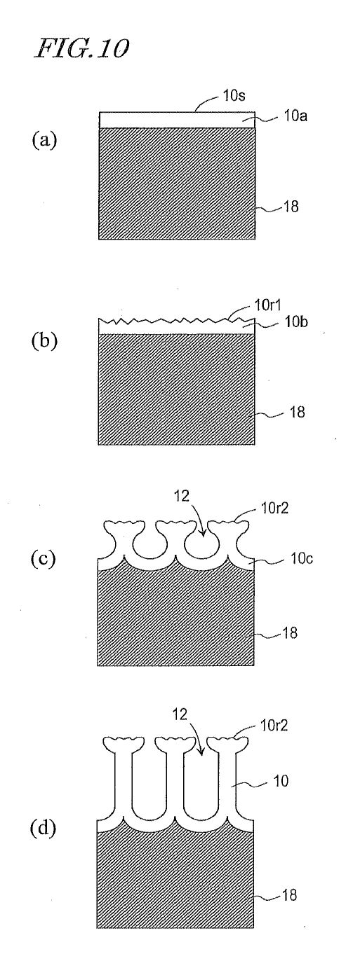

### BRIEF DESCRIPTION OF DRAWINGS

[FIG. 1](a) is a schematic cross-sectional view of an aluminum base 18 which has a damaged layer 18a. (b) is a schematic cross-sectional view of an aluminum base 18 where a porous alumina layer 10 is formed on a damaged layer 18a. (c) is a schematic cross-sectional view of an aluminum base 18 where a porous alumina layer 10 is formed after removal of a damaged layer 18a.

[FIG. 2](a) to (f) are schematic cross-sectional views for illustrating an anodized layer formation method of an embodiment of the present invention.

[FIG. 3] A schematic diagram for illustrating the principle of cathode electrolysis which is used in an anodized layer formation method of an embodiment of the present invention.

[FIG. 4] A photographic image showing a surface of a porous alumina layer which was formed over a mirror-cut surface of an aluminum base according to an anodized layer formation method of an embodiment of the present invention.

[FIG. 5](a) is a SEM image of a mirror-cut surface of an aluminum base on which cathode electrolysis was performed. (b) is a SEM image of the surface on which was anodization was further performed (inventive example).

[FIG. 6](a) is a SEM image of a mirror-cut surface of an aluminum base. (b) is a SEM image of a mirror-cut surface of an aluminum base which was obtained after anodization, without performing cathode electrolysis on the mirror-cut surface (comparative example).

[FIG. 7] A graph which illustrates the effect of cathode electrolysis on anodization, showing the variation of a current over time during anodization with a constant voltage.

[FIG. 8](a) is a photographic image of a mirror-cut surface of an aluminum base. (b) is a photographic image of the surface obtained after anodization was performed on the aluminum base shown in (a). (c) is a SEM image of the surface shown in (b).

[FIG. 9] A graph which illustrates the mechanism of formation of a porous alumina layer, showing the variation of a current over time during anodization with a constant voltage.

[FIG. 10](a) to (d) are schematic cross-sectional views for illustrating the mechanism of formation of a porous alumina layer.

### DESCRIPTION OF EMBODIMENTS

Hereinafter, an anodized layer formation method, a mold manufacturing method, and a mold according to embodiments of the present invention are described with reference to the drawings. Note that the present invention is not limited to illustrated embodiments.

The present invention was conceived for solving a new problem found by the present inventor that, as previously described with reference to FIG. 8, anodizing a surface of an aluminum base which has a damaged layer formed by machining leads to nonuniform formation of minute recessed portions.

As well known in the fields of metalworking, the damaged layer refers to a surface layer whose material properties are changed by working (herein, machining). The damaged layer is estimated to be formed due to irregularity or increase of lattice defects by plastic deformation, or deformation, size reduction or surface flow of crystal grains. Since the damaged layer has a residual strain (residual stress), the presence of a damaged layer and the magnitude of the residual strain can be detected by strain measurement with utilization of X-ray diffraction. In general, it is commonly known that the depth of the damaged layer formed by cutting is about 400 μm at the maximum (for example, Hidehiko TAKEYAMA, University Lectures—Cutting, p. 132, (H7), Maruzen Company, Limited).

The causes of failure to uniformly form minute recessed and raised portions in anodization of a mirror-cut surface and the mechanism by which the above problems are solved according to an anodized layer formation method of the present invention are described hereinbelow. Note that the description provided below is merely a study which is based on the fact experimentally confirmed by the present inventor and is provided as an aid for understanding the present invention. It is not intended to limit the present invention to the description provided below.

First, the mechanism of formation of a porous alumina layer by anodization of aluminum is described with reference to FIG. 9 and FIG. 10.

FIG. 9 is a graph for illustrating the mechanism of formation of a porous alumina layer. This graph shows the variation of a current over time during anodization with a constant voltage. FIGS. 10(a) to 10(d) are schematic cross-sectional views for illustrating the mechanism of formation of a porous alumina layer. FIG. 10(a), FIG. 10(b), FIG. 10(c) and FIG. 10(d) schematically show the progress of anodization, respectively corresponding to the four modes I, II, III and IV of FIG. 9.

When a surface of an aluminum base is anodized in an electrolytic solution with a constant voltage, the current varies as shown in FIG. 9. According to this current variation profile, the anodization can be separated into the four modes I, II, III and IV. The respective modes are described with reference to FIG. 10(a), FIG. 10(b), FIG. 10(c) and FIG. 10(d).

Mode I (FIG. 10(a)): An anodized alumina layer 10a (sometimes simply referred to as “film”) formed over a surface of an aluminum base 18 is very thin, so that there is an anodic field in the film 10a and at the interface between the film 10a and the electrolytic solution. Since the electric field is intense, the concentration of anion A^{m-} at the interface does not substantially depend on the pH of the solution, and the dissolution rate would not vary depending on the pH. Thus, substantially the same reaction occurs irrespective of the type of the electrolytic solution. Here, a surface 10s of the film 10a is flat.

Mode II (FIG. 10(b)): As the thickness of a film 10b increases, a surface 10r1 of the film 10b becomes slightly rough. Thus, the surface 10r1 has minute recessed and raised portions. Due to these recessed and raised portions, the distribution of the current density becomes nonuniform, leading to local dissolution.

Mode III (FIG. 10(c)): Part of the roughness (recessed and raised portions) produced in the surface 10r1 in Mode II grow to form minute recessed portions 12. The metal/film interface (the interface between the aluminum base 18 and an anodized alumina layer 10c) is deformed into the shape of a bowl, so that the area of local dissolution increases. As a result, the total apparent current increases. The dissolution is restricted within the bottoms of the recessed portions 12 at which the electric field density is strongest.

Mode IV (FIG. 10(d)): The recessed portions (micropores) 12 stably grow.

The current profile obtained when the mirror-cut surface is anodized fell within a short period of time and, thereafter, did not substantially vary, as shown by the curve of Condition 4 in FIG. 7 (i.e., anodization in a 0.1 M oxalic aqueous solution with a constant voltage of 60 V). Thus, the current profile has no parts corresponding to Modes III and IV, from which it is inferred that minute recessed portions (micropores) 12 did not formed. The cause of this failure is estimated that there is a damaged layer formed in the mirror-cut surface (mirror-finished surface), and the presence of this damaged layer disturbed production of surface roughness to a degree such that a nonuniform current density distribution occurs in Mode II.

It is estimated that the process of producing roughness in Mode II involves chemical dissolution. Although a porous alumina layer which is used as a motheye mold suitable to formation of an antireflection structure has a critical problem that sufficient roughness is not obtained in Mode II because the electrolytic solution used has relatively low chemical dissolution power, the same tendency occurs irrespective of the conditions of anodization (e.g., including the chemical dissolution power of the electrolytic solution).

The machining process described in the above example is a mirror-finishing process by means of cutting. However, the present invention is not limited to that example. The above description applies to other mirror-finishing processes, such as mirror polishing, mirror grinding, etc. The above description also applies to common machining processes to form a damaged layer.

The present invention was conceived based on the above-described knowledge that was found by the present inventor. An anodized layer formation method of an embodiment of the present invention includes the step of forming a minute uneven structure of recessed and raised portions on a machined surface such that the minute uneven structure has a smaller neighboring distance than a plurality of minute recessed portions 12 of an intended porous alumina layer (see the surface 10r1 of FIG. 10(b) and the surface 10r2 of FIG. 10(c)). The step of forming the minute uneven structure may be realized by performing electrolytic polishing on the machined surface or bringing the machined surface into contact with an etchant.

An anodized layer formation method of another embodiment of the present invention includes the step of allowing passage of an electric current between a surface of an aluminum base and a counter electrode with the surface of the aluminum base being a cathode (cathode electrolysis) in water or an aqueous solution whose specific resistance value is not more than 1 MΩ·cm.

As will be described later with an inventive example, according to an anodized layer formation method of an embodiment of the present invention, a porous alumina layer which has uniformly-distributed minute recessed portions can be formed using the aluminum base 18 that includes a main base body 18b and a damaged layer 18a formed over a surface of the main base body 18b, which is the surface layer of the aluminum base 18, as shown in FIG. 1(a). Thus, using an anodized layer formation method of an embodiment of the present invention enables manufacturing of a mold which has an inverted motheye structure in a mirror-finished surface of an aluminum base. A mold that has a porous alumina layer in a mirror-finished surface, which has a plurality of minute recessed portions whose two-dimensional size viewed in a direction normal to the surface is not less than 10 nm and less than 500 nm, is suitably used in formation of a clear-type antireflection structure. Note that the clear-type antireflection structure refers to an antireflection structure which does not have an antiglare function. As a matter of course, as described above, as described in Patent Documents 1, 2 and 4, an uneven structure for formation of an uneven structure which is larger than the motheye structure (macro structure), which is for the purpose of adding an antiglare function to the antireflection structure, may be superimposed.

According to an anodized layer formation method of an embodiment of the present invention, a porous alumina layer 10 can be formed on the damaged layer 18a of the aluminum base 18 as shown in FIG. 1(b). Also, as shown in FIG. 1(c), a porous alumina layer 10 can be formed after removal of the damaged layer 18a from the aluminum base 18 shown in FIG. 1(a). The base of FIG. 1(b) and the base of FIG. 1(c), on which the porous alumina layer 10 is formed, each can be used as a motheye mold without any modification.

Therefore, by providing a base in the form of a roll as the aluminum base 18 shown in FIGS. 1(a) to 1(c), a motheye mold can be manufactured which has minute recessed portions uniformly formed in a mirror-finished perimeter surface.

Hereinafter, the anodized layer formation method of the embodiment of the present invention is described in more detail with reference to FIG. 2 to FIG. 7.

FIGS. 2(a) to 2(f) are schematic cross-sectional views for illustrating the anodized layer formation method of the embodiment of the present invention.

First, as shown in FIG. 2(a), an aluminum base 18 which has a machined surface is provided. For example, an aluminum base 18 which has a mirror-cut surface is provided as shown in FIG. 8(a). The aluminum base 18 includes a main body 18b and a damaged layer 18a. A surface 18s of the damaged layer 18a is a mirror-finished surface.

Then, as shown in FIG. 2(b), a minute uneven structure is formed in the surface 18s of the damaged layer 18a by means of, for example, cathode electrolysis. Details of the cathode electrolysis will be described later. The minute uneven structure formed in the surface 18s of the damaged layer 18a enables transition of the anodization process to Mode III (see FIG. 9 and FIG. 10). The minute uneven structure formed in a surface 18r has an average neighboring distance which is smaller than the average neighboring distance of a plurality of minute recessed portions of an intended porous alumina layer.

Subsequently, as described in, for example, Patent Document 4, an anodization step and an etching step are alternately repeated multiple times, whereby a porous alumina layer which has minute recessed portions can be formed such that each of the minute recessed portions has a desired cross-sectional shape. Note that, preferably, the final step of the repetition is the anodization step. For example, a porous alumina layer which is suitably used in formation of an antireflection structure can be formed as described below.

As shown in FIG. 2(c), anodization of the surface 18r of the aluminum base 18 leads to formation of a porous alumina layer 10 which has uniformly-distributed minute recessed portions 12. Thus, since the surface 18r of the damaged layer 18a has the minute uneven structure, the anodization process transitions to Mode III and Mode IV without stoppage at Mode II. The anodization is realized by, for example, applying a voltage of 60 V for 40 seconds in a 0.1 M oxalic aqueous solution. Note that, although not shown, the aluminum base 18 shown in FIGS. 2(c) to 2(f) has the damaged layer 18a on the porous alumina layer 10 side.

Then, as shown in FIG. 2(d), the porous alumina layer 10 that has the minute recessed portions 12 is brought into contact with an etchant such that a predetermined amount is etched away. By the etching, the pore diameter of the minute recessed portions 12 is increased. Here, wet etching may be employed, such that the minute recessed portions 12 can be isotropically enlarged. By adjusting the type and concentration of the etchant and the etching duration, the etching amount (i.e., the size and depth of the minute recessed portions 12) can be controlled. The etchant used herein may be, for example, a 5 mass % phosphoric acid or a 3 mass % chromium acid.

Thereafter, the aluminum base 18 is again partially anodized such that the minute recessed portions 12 are grown in the depth direction while the thickness of the porous alumina layer 10 is increased as shown in FIG. 2(e). Here, the growth of the minute recessed portions 12 starts at the bottom of the previously-formed minute recessed portions 12, so that the lateral surface of the minute recessed portions 12 generally has a stepped shape.

Thereafter, when necessary, the porous alumina layer 10 is brought into contact with an etchant of alumina to be further etched such that the diameter of the minute recessed portions 12 is further increased as shown in FIG. 2(f). The etchant used in this step may preferably be the above-described etchant. The same etching bath may be used.

The series of the above processes is preferably ended with the anodization step. When the etching step of FIG. 2(f) is performed, it is preferred that the anodization step is performed one more time. By ending the process with the anodization step (without performing any subsequent etching step), the size of the bottom portion of the minute recessed portions 12 can be decreased. Thus, in a motheye structure which is formed using a resultant motheye mold, the raised portions can have small tips, so that the antireflection effects can be improved.

In this way, by repeating the above-described anodization step (FIG. 2(c)) and etching step (FIG. 2(d)), a porous alumina layer 10 is obtained which has uniformly-distributed minute recessed portions 12 that have a desired shape. By repeating the anodization step and the etching step, the minute recessed portions 12 can be conical recessed portions. By appropriately determining the conditions for each of the anodization steps and the etching steps, the size and depth of the minute recessed portions 12 as well as the stepped shape of the lateral surface of the minute recessed portions 12 can be controlled.

Here, the cathode electrolysis is described with reference to FIG. 3.

The cathode electrolysis refers to passage of an electric current between a surface of an aluminum base and a counter electrode in an aqueous solution as an electrolytic solution, with the surface of the aluminum base being a cathode, as shown in FIG. 3. The aqueous solution used may be an electrolytic solution which is prepared for anodization. The aqueous solution may be replaced by water whose specific resistance value is not more than 1 MΩ·cm.

The reaction which occurs in the electrolytic solution when the cathode is made of Al is expressed by Formula (1) shown below.

2Al+6H₂O→2Al(OH)₃↓3H_{2 ↑} (1)

When an voltage is applied with the cathode made of Al, the total reaction at the cathode includes production of hydrogen and formation of an aluminum hydroxide film over the surface of the aluminum base. Hereinafter, detailed steps of the reaction are described.

At the cathode, an electron donating/receiving reaction expressed by Formula (2) shown below occurs.

Al→Al³⁺+3e⁻ (2)

Also, an electrolytic dissociation of water which is expressed by Formula (3) shown below occurs.

2H₂O [symbol] H₃O⁺+0H⁻ (3)

Also, H₃O⁺ in the aqueous solution receives an electron as expressed by Formula (4) shown below.

2H₃O⁺+2e⁻→H₂↑+2H₂O (4)

When the reaction of Formula (4) occurs, Formula (3) loses its equilibrium so that OH⁻ is locally excessive near the cathode.

As a result, Formula (5) shown below loses its equilibrium so that Al in the surface of the aluminum base reduces.

Al³⁺+3OH⁻ [symbol] Al(OH)₃ (5)

When discussing the reaction velocity, it is necessary to consider the electrolyte. When the aqueous solution is an acidic electrolytic solution (the acid is expressed as HA where H means hydrogen), acid HA dissociates as expressed by Formula (6).

HA+H₂O [symbol] H₃O⁺+A⁻ (6)

As a result of the reaction expressed by Formula (4) shown above, hydrogen is produced (i.e., released from the aqueous solution), so that excessive OH⁻ in the aqueous solution and H₃O⁺ of Formula (6) cause a reaction as expressed by Formula (7) shown below.

H₃O⁺+OH⁻ [symbol] 2H₂O (7)

It is inferred from Formula (2) that the velocity of Formula (5) is proportional to the current density. It is also inferred from Formula (6) and Formula (7) that the velocity of Formula (5) is inversely proportional to the concentration of the electrolytic solution.

In the acidic electrolytic solution, the aluminum hydroxide produced in Formula (5) dissolves as expressed by Formula (8) shown below.

Al(OH)₃+3HA [symbol] Al³⁺+3A⁻+3H₂O (8)

Whether or not the aluminum hydroxide remains in the form of a film depends on the balance of the reaction velocities of Formula (8) and Formula (5) and the surface temperature of the cathode (aluminum base) at the time of formation of the film.

As described above, when the surface of the aluminum base undergoes the cathode electrolysis, aluminum dissolves out from the surface of the aluminum base, so that a minute uneven structure is formed in the surface (see FIG. 2(b)). As a result, a porous alumina film is formed which has uniformly-distributed minute recessed portions as described above.

FIG. 4 is a photographic image showing a mirror-cut surface of the aluminum base (see FIG. 8(a)) on which cathode electrolysis was performed and thereafter anodization was performed. Specifically, the cathode electrolysis was realized by performing the following procedure three times: allowing passage of an electric current of 4 A/dm³ for 30 seconds in a 0.1 M oxalic aqueous solution as the electrolytic solution and, then, pulling the aluminum base out of the electrolytic solution. After the cathode electrolysis, to remove the aluminum hydroxide film formed over the surface of the aluminum base, the aluminum base was immersed in a 1 M phosphoric aqueous solution at 30° C. for 10 minutes. Thereafter, anodization was performed in a 0.1 M oxalic aqueous solution at a constant voltage of 60 V for 2 minutes. As clearly seen from comparison with the photographic image shown in FIG. 8(b) which was obtained after the anodization was performed on the mirror-cut surface (as machined) of the aluminum base, no white striped pattern is seen in the surface shown in FIG. 4, which is an evidence that the formed porous alumina layer has uniformly-distributed minute recessed portions.

The mirror-cut surface of the aluminum base which is shown in FIG. 8(a), the surface shown in FIG. 8(b) which was obtained after the anodization was performed on the mirror-cut surface (as machined) of the aluminum base, and the surface obtained after cathode electrolysis and subsequent anodization were performed on the mirror-cut surface of the aluminum base shown in FIG. 4 were observed by means of SEM. The results of the observation are described below.

FIG. 5(a) shows a SEM image of a surface obtained by performing the cathode electrolysis on the mirror-cut surface of the aluminum base. FIG. 5(b) shows a SEM image of a surface obtained by further performing the anodization (Inventive Example). On the other hand, FIG. 6(a) shows a SEM image of a mirror-cut surface of the aluminum base. FIG. 6(b) shows a SEM image of a surface obtained after the anodization was performed on the mirror-cut surface of the aluminum base, without undergoing the cathode electrolysis (Comparative Example).

First, FIG. 5(a) is compared with FIG. 6(a). As seen from the SEM image of FIG. 6(a), no uneven structure is seen in the mirror-cut surface of the aluminum base, and the surface is very smooth. On the other hand, as seen from the SEM image of FIG. 5(a), in the mirror-cut surface of the aluminum base on which the cathode electrolysis was performed, the minute uneven structure can be seen.

Next, FIG. 5(b) is compared with FIG. 6(b). As seen from the SEM image of FIG. 6(b), the surface only has a small number of minute recessed portions. This conforms to the above description which has been provided with reference to the SEM image shown in FIG. 8(c) whose magnification is smaller than that of the SEM image of FIG. 6(b). On the other hand, as seen from the SEM image of FIG. 5(b), by performing the anodization after the cathode electrolysis on the surface of the aluminum base, the resultant porous alumina layer has uniformly-distributed minute recessed portions.

As seen from the comparison of FIG. 5(a) and FIG. 5(b), the average neighboring distance of the minute uneven structure formed by the cathode electrolysis (FIG. 5(a)) is smaller than the average neighboring distance of a plurality of minute recessed portions of an intended porous alumina layer. This accords with the mechanism of formation of the porous alumina layer which has previously been described with reference to FIG. 9 and FIG. 10.

The effect of the cathode electrolysis on the anodization is described with reference to FIG. 7. FIG. 7 is a graph showing the variation of a current over time during anodization with a constant voltage. The graph shows the results obtained when the cathode electrolysis was performed on the mirror-cut surface of the aluminum base under three different conditions, Conditions 1-3, before the anodization, and the result obtained when only the anodization was performed on the mirror-cut surface, without performing the cathode electrolysis (Condition 4).

Under either of Conditions 1-3, the conditions for the cathode electrolysis were that the electrolytic solution was a 0.1 M oxalic aqueous solution, and the temperature of the solution was 20° C.

Condition 1: Allowing passage of a current of 4 A/dm³ for 30 seconds and then pulling the aluminum base out of the electrolytic solution. This procedure was performed 3 times.

Condition 2: Allowing passage of a current of 1.6 A/dm³ for 30 seconds and then pulling the aluminum base out of the electrolytic solution. This procedure was performed 3 times.

Condition 3: Allowing passage of a current of 1.6 A/dm³ for 30 seconds and then pulling the aluminum base out of the electrolytic solution. This procedure was performed 6 times.

The reason why the aluminum base was pulled out of the electrolytic solution such that the cathode electrolysis was separated into multiple times is to prevent bubbles generated on the surface of the aluminum base that is the cathode from inhibiting the reaction so that the progress of the cathode electrolysis would not hindered in some portions of the surface.

After the cathode electrolysis, to remove the aluminum hydroxide film formed over the surface of the aluminum base, the aluminum base was immersed in a 1 M phosphoric aqueous solution at 30° C. for 10 minutes.

Thereafter, the anodization was performed in a 0.1 M oxalic aqueous solution with a constant voltage of 60 V for 2 minutes. The current profile obtained during the anodization is shown in FIG. 7.

In the case of Condition 4 where the cathode electrolysis was not performed, the profile does not include the phases of the above-described Mode III and Mode IV. Thus, it is inferred that generation and growth of minute recessed portions (micropores) did not occur.

In all of the cases of Conditions 1-3 where the cathode electrolysis was performed, it is seen that the profiles include the phases of four modes, Modes I, II, III and IV. Thus, it is inferred that a minute uneven structure that had a degree of roughness which may be necessary for the progress of Mode III and Mode IV was formed by the cathode electrolysis.

Comparing Condition 1 and Condition 2 between which the current density used for the cathode electrolysis is different, it is seen that the timing of transition from Mode II to Mode III is earlier in Condition 1 (4 A/dm³). This is probably because of the difference in the degree of the surface roughness (minute uneven structure) produced by the cathode electrolysis. It is therefore inferred that an uneven structure which has a smaller average neighboring distance was formed under Condition 1 where the current density is greater than under Condition 2 (1.6 A/dm³).

Comparing Condition 2 and Condition 3 between which the number of times of the cathode electrolysis is different, the current profiles are generally identical. It is thus inferred that the processes from Mode I through Mode IV progressed with generally identical velocities.

It is not the amount of the cathode electrolysis but the current density that dominantly affects the degree of roughness of the minute uneven structure which is necessary for transition from Mode II to Mode III.

As clearly seen from the descriptions provided above, it was experimentally confirmed that, even when a damaged layer is formed over the surface of the aluminum base, performing the cathode electrolysis to form a minute uneven structure over the surface enables formation of a porous alumina layer which has uniformly-distributed minute recessed portions. As a matter of course, when a damaged layer is entirely removed by performing the cathode electrolysis, a porous alumina layer which has uniformly-distributed minute recessed portions can be formed through the process from Mode I to Mode IV which have been described with reference to FIG. 9 and FIG. 10.

The above-described effects of the cathode electrolysis may be achieved by any other method.

For example, electrolytic polishing may be performed on an aluminum base which has a damaged layer over its surface, whereby a minute uneven structure can be formed in the surface. The electrolytic polishing may be realized by any of a wide variety of known methods. Alternatively, the damaged layer can be removed by performing the electrolytic polishing for a sufficiently long period of time.

Alternatively, a minute uneven structure can be formed by bringing an aluminum base which has a damaged layer over its surface into contact with an etchant. For example, the minute uneven structure can be formed in the surface by immersing the aluminum base in a 1 M sulfuric aqueous solution for 1 minute. As a matter of course, the damaged layer can be removed by etching.

An aluminum base which has a porous alumina layer can be used as a mold without any modification. Therefore, the aluminum base preferably has sufficient rigidity. To obtain an aluminum base in the form of a roll, the aluminum base preferably has excellent processibility. From the viewpoint of rigidity and processibility, it is preferred to use an aluminum base which contains an impurity. It is particularly preferred that the content of an element whose standard electrode potential is higher than Al is not more than 10 ppm and that the content of an element whose standard electrode potential is lower than Al is not less than 0.1 mass %. It is particularly preferred to use an aluminum base which contains Mg as an impurity element. Mg is a base metal relative to Al and has a standard electrode potential of −2.36 V. The content of Mg is preferably not less than 0.1 mass % and not more than 4.0 mass % of the whole. Preferably, it is less than 1.0 mass %. If the content of Mg is less than 0.1 mass %, sufficient rigidity cannot be obtained. The solid solution limit of Mg to Al is 4.0 mass %. The content of the impurity element may be appropriately determined depending on the shape, thickness and size of the aluminum base, according to required rigidity and/or processibility. However, in general, if the content of Mg exceeds 1.0 mass %, the processibility decreases. The entire disclosures of Japanese Patent Application No. 2008-333674 and PCT/JP2009/007140 are incorporated by reference in this specification.

When manufacturing a mold in the form of a roll, it is possible to use a mold in the form of a roll which is made of a metal, such as stainless steel (SUS), or a different type of material (e.g., ceramic, glass, or plastic). When using a base in the form of a roll which is made of such a material other than aluminum, a porous alumina layer which has a plurality of minute recessed portions may be formed by depositing an aluminum layer over the perimeter surface of a base in the form of a roll and anodizing the surface of the aluminum layer. The deposition method used may be a known method, such as sputtering or electron beam deposition. The deposited aluminum layer does not have a damaged layer, so that it is not necessary to perform the cathode electrolysis or the like. An aluminum layer is obtained which is formed by deposited crystal grains of about several hundreds of nanometers so long as the surface temperature of the base is controlled to be sufficiently lower than a temperature at which aluminum exhibits solid phase flowability. Since such an aluminum layer has an uneven structure of appropriate roughness in its surface, a porous alumina layer which has uniformly-distributed minute recessed portions can readily be formed.

### INDUSTRIAL APPLICABILITY

The present invention is used for a method for forming an anodized layer in an aluminum base or an aluminum layer, a method for manufacturing a mold, and a mold. Particularly, the present invention is preferably used for a method for manufacturing a motheye mold in the form of a roll.

### REFERENCE SIGNS LIST

10 porous alumina layer
12 minute recessed portions (micropores)
18 aluminum base
18a damaged layer
18b main base body

1. A method for forming an anodized layer, comprising the steps of:
(a) providing an aluminum base which has a machined surface;
(b) allowing passage of an electric current between the surface of the aluminum base and a counter electrode, with the surface of the aluminum base being a cathode, in water or an aqueous solution whose specific resistance value is not more than 1 MΩ·cm; and
(c) after step (b), anodizing the surface of the aluminum base, thereby forming a porous alumina layer.

2. A method for forming an anodized layer, comprising the steps of:
(a) providing an aluminum base which has a machined surface;
(b) forming, in the surface of the aluminum base, a minute uneven structure which has a smaller average neighboring distance than an average neighboring distance of a plurality of minute recessed portions that an intended porous alumina layer has; and
(c) after step (b), anodizing the surface of the aluminum base, thereby forming a porous alumina layer which has the plurality of minute recessed portions.

3. The method of claim 2, wherein step (b) includes performing electrolytic polishing on the surface of the aluminum base.

4. The method of claim 2, wherein step (b) includes bringing the surface of the aluminum base into contact with an etchant.

5. The method of claim 1, wherein the machined surface is a mirror-finished surface.

6. The method of claim 1, wherein the aluminum base is in the form of a roll.

7. A method for forming an anodized layer, comprising the steps of:
(a) providing a base in the form of a roll;
(b) depositing an aluminum layer on a perimeter surface of the base that is in the form of a roll; and
(c) anodizing the surface of the aluminum layer, thereby forming a porous alumina layer which has a plurality of minute recessed portions.

8. A method for manufacturing a mold which has an inverted motheye structure in its surface, comprising the step of forming a porous alumina layer according to the anodized layer formation method of claim 1, the porous alumina layer having a plurality of minute recessed portions whose two-dimensional size viewed in a direction normal to the surface is not less than 10 nm and less than 500 nm.

9. A mold, comprising:
an aluminum base which has a mechanically damaged layer; and
a porous alumina layer formed over the mechanically damaged layer.
